(19) United States
(12) Patent Application Publication
(10) Pub. No.: US 2023/0413910 A1
(43) Pub. Date: Dec. 28, 2023

(54) AEROSOL PROVISION DEVICE

(71) Applicant: Nicoventures Trading Limited, LONDON (GB)

(72) Inventors: David BUREAU, London (GB); James SHERIDAN, London (GB); Daniel LOCHTMAN, London (GB)

(21) Appl. No.: 18/248,308

(22) PCT Filed: Oct. 12, 2021
(86) PCT No.: PCT/EP2021/078202

§ 371 Date: Apr. 7, 2023

(30) Foreign Application Priority Data
Oct. 16, 2020 (GB) 2016480.2

(51) Int. Cl. A24F 40/465; A24F 40/20; A24F 40/48; H05B 6/10

(52) U.S. Cl. CPC A24F 40/465; A24F 40/20; A24F 40/48; H05B 6/105

(57) ABSTRACT

An aerosol provision device can include a heater assembly. The heater assembly has a heating chamber arranged to receive at least a portion of an article comprising aerosol generating material, and a heating element configured to heat a portion of the article received in the heating chamber. A base is provided at one end of the heating chamber. A spacer is also provided to space the article from the base when at least the portion of the article is received in the heating chamber.

### PRIORITY CLAIM

The present application is a National Phase entry of PCT Application No. PCT/EP2021/078202, filed Oct. 12, 2021, which claims priority from GB Application No. 2016480.2, filed Oct. 16, 2020, each of which hereby fully incorporated herein by reference.

### TECHNICAL FIELD

The present disclosure relates to an aerosol provision device, a heating assembly for receiving at least a portion of an article comprising aerosolizable material, and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device comprising: a heater assembly having a heating chamber arranged to receive at least a portion of an article comprising aerosol generating material, and a heating element configured to heat a portion of the article received in the heating chamber; a base at one end of the heating chamber; and a spacer configured to space the article from the base when at least the portion of the article is received in the heating chamber.

The spacer may comprise a protrusion protruding into the heating chamber. The protrusion may be one of a plurality of protrusions.

The plurality of protrusions may be distributed around the heating chamber. The protrusion or each protrusion may comprise a tab. The protrusion or each protrusion may extend from the base. The protrusion or each protrusion may be spaced from the base.

The spacer may comprise a step. The spacer may form a shoulder in the heating chamber.

The heating element may upstand from the base. The heating element may protrude in the heating chamber. The heating element may be a blade.

The aerosol provision device may comprise a receptacle defining the heating chamber. The base may form part of the receptacle.

The aerosol provision device may comprise a device housing, wherein the receptacle is removable from the device housing.

The receptacle may be fixedly mounted in the device housing.

The receptacle may comprise a wall upstanding from the base to define the heating chamber. The wall may be tubular.

The receptacle may define an air passage to provide airflow to the heating chamber.

The air passage may comprise an air outlet into the heating chamber. The air outlet may be defined in the base.

The air outlet may be non-symmetrical about an axis of the heating chamber.

The air outlet may be offset from an axis of the heating chamber.

The air passage may comprise an air outlet into the heating chamber. The air outlet may be at least partially disposed between the base and an article locating face of the spacer.

The air outlet may be arranged to introduce air flow into the heating chamber in a radial direction relative to a longitudinal axis of the receptacle.

The air outlet may be arranged to introduce air flow into heating chamber in a co-axial direction relative to the longitudinal axis of the receptacle.

The wall may comprise an outer wall and an inner wall, wherein the air passage is formed between the outer wall and inner wall.

The base and the outer wall may be integrally formed. The base and the outer wall may form a cup. The cup may form a fluid barrier.

The air passage may be a closed channel.

The heating element may comprise a susceptor which is heatable by penetration with a varying magnetic field.

The heater assembly may comprise an inductor coil extending around the susceptor, wherein the inductor coil is configured to generate the varying magnetic field.

The heating element may surround the heating chamber.

The heating element may define part of the receptacle.

The aerosol provision device may comprise an opening at a proximal end of the heating chamber, and wherein the base may be at a distal end of the heating chamber, and wherein the heating chamber may have a substantially uniform cross section along substantially the length of the receptacle,

The base may include a well configured to collect liquid collated in the heating chamber.

According to an aspect, there is provided a heating assembly, comprising: a receptacle for receiving at least a portion of an article comprising aerosolizable material; the receptacle comprising: a base; a heating element extending from the base; and a protrusion for contacting the portion of the article when the portion of the article is received in the heating chamber such that the article is maintained a distance above the base.

According to an aspect, there is provided an insert for an aerosol provision device comprising: a receptacle arranged to be at least partially removably received in a device housing, the receptacle defining a heating chamber arranged to receive at least a portion of an article comprising aerosol generating material, the receptacle comprising: a base at one end of the heating chamber; and a spacer configured to space the article from the base when at least the portion of the article is received in the heating chamber; and the insert comprising: a heating element configured to heat a portion of the article received in the heating chamber.

According to an aspect, there is provided an aerosol provision device comprising: a heater assembly having: a heating chamber arranged to receive at least a portion of an article comprising aerosol generating material, and a heating element configured to heat a portion of the article received in the heating chamber; a wall defining at least part of the heating chamber; and a cavity formed in the wall.

The aerosol provision device may comprise a base at one end of the heating chamber, wherein the wall comprises the base and the cavity is in the base.

The aerosol provision device may comprise a peripheral wall defining the heating chamber, wherein the wall comprises the peripheral wall and the cavity is in the peripheral wall.

The cavity may be one of a plurality of cavities formed in the wall. The or each cavity may be distributed about the heating element.

The aerosol provision device may comprise a device housing and a receptacle arranged to be at least partially removably received in the device housing, wherein the removable receptacle forms the heating chamber.

The receptacle may comprise the wall.

The aerosol provision device may comprise a spacer configured to space the article from the cavity when at least the portion of the article is received in the heating chamber.

According to an aspect, there is provided an insert for an aerosol provision device comprising: a receptacle arranged to be at least partially removably received in a device housing, the receptacle defining a heating chamber arranged to receive at least a portion of an article comprising aerosol generating material, the receptacle comprising: a wall defining at least part of the heating chamber; and a cavity formed in the wall; and the insert comprising: a heating element configured to heat a portion of the article received in the heating chamber.

The heating element may be fluidly sealed with the receptacle.

According to an aspect, there is provided a heating assembly, comprising: a heating chamber for receiving at least a portion of an article comprising aerosolizable material; and a heating element; wherein the heating chamber has a base and a recess in the base for collecting fluid expelled from an article received in the heating chamber.

According to an aspect, there is provided an aerosol provision system comprising: an aerosol provision device, a heating assembly or an insert as described above, and an article comprising aerosol generating material, wherein the article is dimensioned to be at least partially received within the heater assembly.

According to an aspect, there is provided an aerosol provision device comprising: a heater assembly having: a heating chamber arranged to receive at least a portion of an article comprising aerosol generating material, a heating element configured to heat a portion of the article received in the heating chamber; and a base at one end of the heating chamber.

The device may be a tobacco heating device, also known as a heat-not-burn device.

Further features and advantages of the disclosure will become apparent from the following description of embodiments of the disclosure, given by way of example only, which is made with reference to the accompanying drawings.

### BRIEF DESCRIPTION OF THE DRAWINGS

FIG. 1 shows a perspective view of an example of an aerosol provision device.

FIG. 2 shows a cross-sectional front view of the aerosol provision device of FIG. 1.

FIG. 3 shows a close up cross-sectional front view of part of FIG. 2.

FIG. 4A shows a perspective view of the heater assembly in isolation from the rest of the device.

FIG. 4B shows a cross-sectional view of the heater assembly of FIG. 4A.

FIG. 5 shows a close up cross-sectional side view of part of the heater assembly of FIG. 4A.

FIG. 6 shows a perspective cross-sectional exploded view of a receptacle of the heater assembly.

FIG. 7 shows a close up cross-sectional front view of part of another heater assembly.

FIG. 8 shows a close up cross-sectional front view of part of another heater assembly with a consumable inserted into a heating chamber of the heater assembly.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

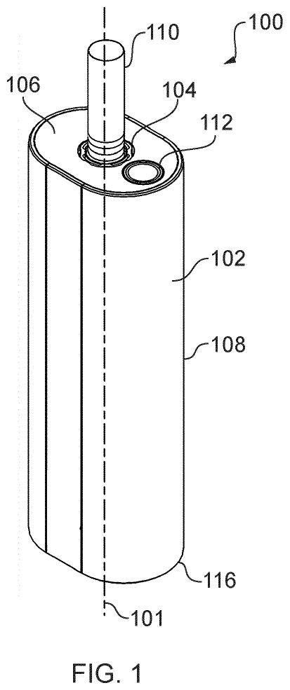

FIG. 1 shows an example of an aerosol provision device 100 for generating aerosol from an aerosol generating medium/material. In broad outline, the device 100 may be used to heat a replaceable article 110, also known as a consumable, comprising the aerosol generating medium, to generate an aerosol or other inhalable medium which is inhaled by a user of the device 100.

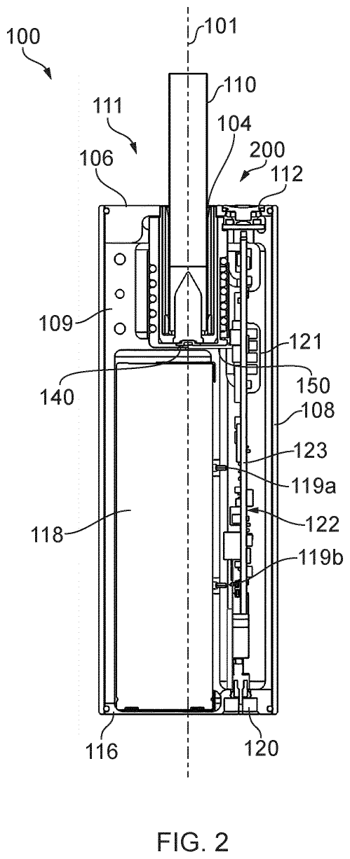

The device 100 comprises a housing 102 (including an outer cover 108) which surrounds and houses various components of the device 100. The device 100 has an opening 104 in one end, through which the article 110 may be inserted for heating by a heater assembly 200 (refer to FIG. 2). In use, the article 110 may be fully or partially inserted into the heater assembly 200 where it may be heated by one or more components of the heater assembly 200.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic cross-sectional front view of the device 100 of FIG. 1. The device 100 comprises the outer cover 108, a first end member 106 and a second end member 116. The device 100 includes a chassis 109, a power source 118, and an aerosol generating assembly 111 including the heater assembly 200. The device 100 further comprises at least one electronics module 122.

The outer cover 108 forms part of a device shell. The first end member 106 is arranged at one end of the device 100 and the second end members 116 is arranged at an opposite end of the device 100. The first and second end members 106, 116 close the outer cover 108. The first and second end members 106, 116 form part of the housing. The device 100 in embodiments comprises a lid (not shown) which is moveable relative to the first end member 106 to close the opening 104 when no article 110 is in place.

The device 100 may also comprise an electrical component, such as a connector/port 120, which can receive a cable to charge a battery of the device 100. For example, the connector may be a charging port, such as a USB charging port. In some examples the connector may be used additionally or alternatively to transfer data between the device 100 and another device, such as a computing device.

The device 100 includes the chassis 109. The chassis 109 is received by the outer cover 108. The aerosol generating assembly 111 comprises the heater assembly 200 into which, in use, the article 110 may be fully or partially inserted where it may be heated by one or more components of the heater assembly 200. The aerosol generating assembly 111 and the power source 118 are mounted on the chassis 109. The chassis 109 is a one piece component.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 108 may also define a portion of the end surfaces. The first and second end members 116 close open ends of the outer cover 108. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generating assembly 111 to supply electrical power when required and under control of a controller 121 to heat the aerosol generating material.

The power source 118 and aerosol generating assembly 111 are disposed in an axial arrangement, with the power source 118 at the distal end of the device 100 and the aerosol generating assembly 111 at the proximal end of the device 100. Other configurations are anticipated.

The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals 119a, 119b may be electrically connected to the PCB 123 so that power can be distributed throughout the device 100. The connector 120 may also be electrically coupled to the battery 118 via the electrical tracks.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

A temperature sensor in the form of a thermocouple 150 is in thermal communication with the susceptor, and is connected to the electronics module 122. In the depicted embodiment, a thermally conductive plate 140 is placed between the thermocouple 150 and the susceptor to facilitate thermal communication between the thermocouple 150 and the susceptor. In other examples, the plate 140 can be omitted.

The thermocouple 150 monitors the temperature of the susceptor during use of the device 100 and feeds this information to the electronics module 122. This allows the electronics module 122 and the controller 121 to monitor and adjust the temperature of the susceptor as may be necessary during use of the device 100, e.g. by adjusting the amount of electrical power supplied by the power source 118. The thermocouple 150 can be any suitable thermocouple, such as a platinum rhodium thermocouple (i.e. B type).

Compared to other devices for sensing temperature, the thermocouple 150 may facilitate more robust, durable, power-efficient and accurate temperature measurements. Nonetheless, in other examples within the scope of this disclosure, the temperature sensor can be any other suitable temperature sensor, such as a resistance temperature detector, thermistor, infra-red sensor etc.

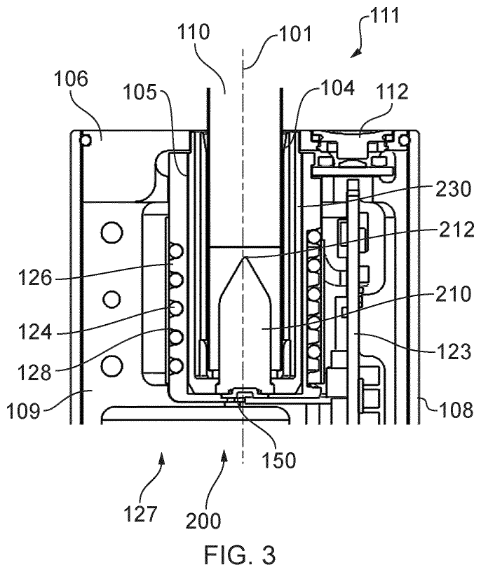

FIG. 3 shows a close up view of part of the aerosol generating assembly 111 in cross-section that includes the heater assembly 200 and an inductor coil assembly 127.

The aerosol generating assembly 111 comprises the inductor coil assembly 127 and the heater assembly 200. The inductor coil assembly 127 extends around the heater assembly 200. The inductor coil assembly 127 comprises a coil support 126. The inductor coil assembly 127 includes an inductor coil 124 wrapped around (i.e. surrounding) the heater assembly 200. The inductor coil 124 is disposed in a groove 128 defined in the support 126. The groove 128 is helical. The groove 128 may be omitted, and the coil 124 wrapped around an outer surface of the coil support 126. The inductor coil assembly 127 is fixedly mounted in the device housing 102. The coil support 126 may form part of the device housing 102.

The heater assembly 200 includes a heating element 210 for heating the article 110 during use. In the exemplified embodiment of FIG. 3, the heating element is a susceptor arrangement 210 (herein referred to as “a susceptor”). The susceptor 210 of this example is a blade-shaped susceptor 210. The article 110 can be inserted onto or around the susceptor 210. The blade-shaped susceptor 210 may have a constant rectangular cross-section along the majority of its axial length and then taper to a blade tip 212 at a free end. In other examples, the axial cross-section may vary along the axial length of the susceptor 210 to the blade tip 212.

Although a blade-shaped susceptor 210 is depicted, it is to be understood than any other suitable shape or form of susceptor 210 may be used within the scope of this disclosure. For example, the susceptor 210 could be pin-shaped e.g. with a constant circular cross-section along its axial length that tapers to a pin tip, or rod-shaped (e.g. a cylindrical rod or a square rod) with a constant or varying cross-section along its axial length that omits a tip or tapered portion. In further examples, the susceptor 210 may instead be a tubular member within which the article 110/aerosol generating material is received. Such a susceptor is an outer susceptor. In such an example, the susceptor may define a peripheral wall (e.g. an annular wall) that defines at least part of a heating chamber within which the article 110 can be received and heated. In such an example, the susceptor surrounds the article 110, instead of the article 110 surrounding the susceptor as in the blade-shaped embodiment discussed above. It will be understood that the cross-sectional profile of the outer susceptor may be formed in a variety of profile shapes.

In further examples, multiple susceptors (e.g. two or more separate susceptors) may also be provided, and may be of differing or similar configurations (e.g. pin-shaped, blade-shaped, rod-shape or tubular-type etc.), as required.

The susceptor 210 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The heater assembly 200 may therefore comprise electrical contacts for electrical connection with the apparatus for electrically activating the heating element by passing a flow of electrical energy through the heating element. In such embodiments, inductive coil assembly 127 can be omitted as appropriate.

The inductor coil 124 is made from an electrically conducting material. In this example, the inductor coil 124 is made from Litz wire/cable which is wound in a helical fashion to provide a helical inductor coil 124. Litz wire comprises a plurality of individual wires which are individually insulated and are twisted together to form a single wire. Litz wires are designed to reduce the skin effect losses in a conductor. In the example device 100, the inductor coil 124 is made from copper Litz wire which has a circular cross section. In other examples the Litz wire can have other shape cross sections, such as rectangular. The inductor coil 124 can be connected to the PCB 123 to control the activation of inductive heating therefrom using the electronics module 122 and switch 112.

The number of inductor coils used may also differ. For example, although the aerosol generating assembly 111 shown in FIG. 3 includes an inductor coil assembly 127 with only a single coil 124, it should be understood that the inductor coil assembly 127 can feature any number of suitable coils. Additional coils may be used to provide different heating zones with different heating characteristics for the susceptor 210 (e.g. provide different heating conditions to different areas along the axial length of the susceptor 210 and/or provide different heating conditions to the susceptor 210 at different times or for different use cases). Additional coils may also be provided to generate heating in additional susceptors that may be disposed in the aerosol generating assembly 111 (not shown).

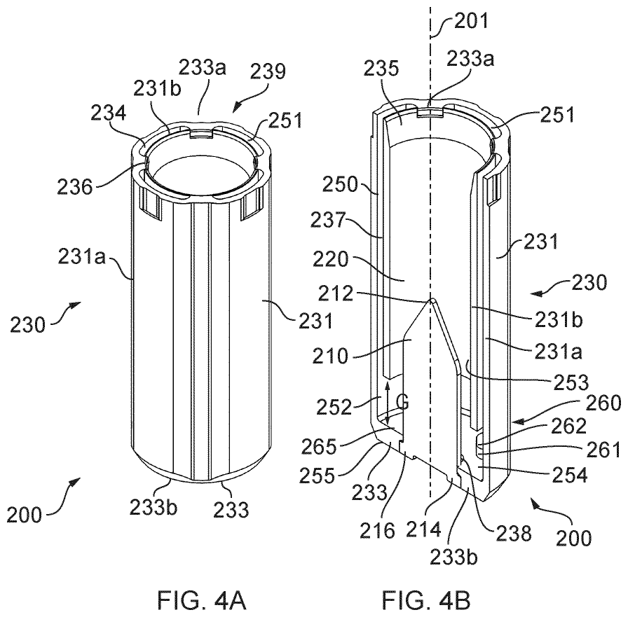

The heater assembly 200 includes a receptacle 230 (shown in more detail in FIGS. 4A and 4B). The receptacle 230 defines a heating chamber 220 within which the article 110 is received during use. In the depicted embodiment, the receptacle 230 is an annular body that encircles the susceptor 210 and provides an annular space between the susceptor 210 and the receptacle within which the article 110 can be received and heated during use.

The coil support 126 and opening 104 define a device chamber 105 within the device housing 102 that receives the receptacle 230. The receptacle 230 interacts with the device housing 102 in order to secure the heater assembly 200 in place. The coil support 126 forms part of the device housing 102. In embodiments, the device chamber 105 is defined by another feature other than the coil support 126. The coil support 105 forms an internal wall. The internal wall is cup shaped.

The receptacle 230 is removably disposed within the chamber 105, such that it can be removed therefrom and replaced therein during use. This feature facilitates the cleaning of the receptacle 230 (and other heater assembly components part thereof), as well as replacement of the receptacle 230 (and other heater assembly components part thereof) in the event of breakage or failure.

In the depicted example, the receptacle 230 is completely disposed inside the chamber 105. In other examples, when the receptacle 230 is received in the chamber 105 a portion of the receptacle 230 (e.g. such as a lip or a flange at its proximal end) may still extend outside of the device chamber 105. In such examples, the receptacle 230 may therefore be ‘partially removably disposed’ in the chamber 105. This disclosure covers all such examples.

FIGS. 4A and 4B show the heater assembly 200 in more detail. The heater assembly 200 forms an insert. In the present arrangement the insert comprises the receptacle 230 and heating element 210. In embodiments, the insert comprises the receptacle 230. The receptacle 230 includes a base 233 and a wall 231. The wall arrangement upstands from the base 233. An opening 239 is defined at a proximal end 233a of the receptacle 230. The base 233 is formed at the distal end 233b. The wall 231 comprises outer and inner walls 231a, 231b. The outer and inner walls 231a, 231b are concentric with each other about the longitudinal axis 201 of the heater assembly 200. The outer wall 231a forms an outer shell. The inner wall 231b forms an inner shell. As shown in FIGS. 2 and 3, when the heater assembly 200 is inserted into the device housing chamber 205, the longitudinal axis 201 of the heater assembly 200 is substantially co-axial with the longitudinal axis 101 of the device 101.

The outer wall 231a extends axially from the opening end 233a to the opposing base end 233b of the receptacle 230. The outer wall 231a may define the base 233 itself, and be integrally formed therewith. Alternatively, the base 233 could be attached to the outer wall 231a separately. The outer wall 231a and base 233 forms a cup. The cup forms a fluid barrier. The opening end 233a is so called, because it is the end of the heater assembly 200 that sits in the opening 104 of the device 100 when the receptacle is inserted into the device housing chamber 105. Accordingly, as discussed above in relation to the device 100, the opening end 233a may also be referred to as the proximal end (or mouth end) of the heater assembly 200, whilst the base end 233b may be referred to as the distal end of the heater assembly 200.

The base 233 defines an aperture 238 therein within which the heating element 210 is received and protrudes (axially) therefrom. The heating element 210 defines a heating element base 214 forming an anchoring flange 216. The heating element base 214 may be press-fit into the aperture 238. However, any other suitable method of securing the heating element 210 in place in the receptacle 230 may be used e.g. welding, insert molding, interference fit, threaded fitment etc. The heating element 210 forms a fluid seal with the receptacle 230. A seal may be disposed to form a fluid seal between the heating element 210 and the receptacle 230. In embodiments, aperture 238 could instead be a blind cavity/recess or may be omitted completely depending on the securing method used to attached the heating element 210 in place in the receptacle 230.

In the depicted embodiment, the heating element 210 is fixedly attached to the receptacle 230, such that it is a part of the receptacle 230 itself and is supported thereby. In this manner, the heating element 210 is removable from the device housing chamber 105, with and as part of the receptacle 230.

In alternative embodiments, the heating element 210 may instead be fixedly attached to the device housing 102 within the device housing chamber 105, instead of the receptacle 230. In this manner, whilst the receptacle 230 is removed from the device housing chamber 105 the heating element 210 will remain fixed in place within the device housing chamber 105.

In either of the above alternatives, the heating element 210 may additionally be separately removable from the device housing 102 and/or the receptacle 230 itself. For example, the heating element 210 could be removable fixed to either of the receptacle 230 or the device housing 102/chamber 105 instead of fixedly attached thereto. For example, by being threadably received therein, being received by a bayonet fitting therein, or using connectors on the heating element 210 that interference fit with corresponding connectors on the device housing 102/chamber 105, and which can be pulled apart.

This may facilitate cleaning and/or replacement of the heating element 210. This improvement in replacement of the heating element 210 may be useful in the event that the heating element 210 is broken or has failed and needs to be replaced, but may also be useful for interchanging different heating elements 210 for different use cases. For example, when a certain use case or article 110 may demand a different shape/type of heating element 210 to another.

The inner wall 231b is spaced from the outer wall 231a. An air path 250 is defined along the receptacle 230 from the opening end 233a to the base end 233b. The air path extends in an axial direction. The air path has an air inlet 251 at the proximal end 233a. The air path 250 has an air outlet 252 at the distal end 233b.

The inner wall 231b extends axially from the proximal end 233a towards the base end 233b. The inner wall 231b is spaced from the base 233. The inner wall 231b stops axially short of the base 233 to form an axial gap G between the inner wall 231b and the base 233. In the depicted example, the axial gap G provides an annular gap around the heating element 210 between the base 233 and the inner wall 231b. The gap between the inner wall 231b and the base 233 defines the air outlet 251. In embodiments, the inner wall 231b extends to the base 233 and apertures and/or cutaways are formed in the base end of the inner wall 231b to define the air outlet 251, as will be described below.

The inner wall 231b features a tapered surface 235 at the proximal end 233a. The tapered surface 235 tapers at an angle towards the longitudinal axial 201 from the proximal end 231b. The tapered surface 235 may help facilitate insertion of the article 110 into the heater assembly 200 and heating chamber 220. For example, it may facilitate correct alignment of the article 110 when it is insert into the heating chamber 220 around the heating element 210.

The outer wall 231a and inner wall 231b are spaced radially apart. The outer and inner walls 231a, 23b are connected by radially extending ribs 236. The ribs 236 secure the inner wall 231b in place within the outer wall 231a. There are a discrete number of ribs 236 disposed between the outer and inner walls 231a, 231b around the circumference of the walls 231a, 231b. In the illustrated example, there are four such ribs 236 spaced equally around the circumference of the walls 231a, 231b. However, any suitable number and spacing of ribs 236 can be used.

In the depicted embodiment, the ribs 236 extend axially the length of the inner wall 231b. However, the ribs 236 may extend any suitable axial distance between the walls 231a, 231b that is sufficient to provide the required support for holding the walls 231a, 231b concentrically in place relative to each other.

The combination of the outer wall 231a, inner wall 231b and ribs 236 define slots 234 at the proximal end 233a and form passages 237 that extend axially within the receptacle 230. The passages 237 define the air path 250. The slots 234 define the air inlet 251.

The number and size of slots 234 and passages 237 can be varied as necessary depending on the size, spacing and number of ribs 236. Moreover, the slots 234 and passages 237 needn't be defined at the proximal end 233a. For example, the ribs 236 could be present at any suitable axial location within the receptacle 230, e.g. nearer the base 231b or midway along the axial length of the walls 231a, 231b. Moreover, the slots 234 and passages 237 could instead provide a single (e.g. substantially annular) slot 234/passage 237 that extends axially between the inner and outer walls 231a, 231b.

In the depicted embodiment, the passages 237 are used as airflow passages that permit the communication of airflow from the exterior of the device 100 to the heating chamber 220 and the aerosol generating materials therein during use. The inlet of airflow from the proximal end 233a via slots 234 and passages 237 is convenient, as the user is unlikely to block airflow to such a region when using the device 100.

The passages 237 exit into the annular space provided by gap G, which in use allows airflow to be communicated from the passages 237 into the heating chamber 220, and through the aerosol generating material/article 110 received therein.

The presence of passages 237 between the inner and outer walls 231a, 231b can allow for improved control of the airflow and resistance to airflow through the passages 237. For example, it may allow the use of airflow modifying features (e.g. airflow constrictors) to be placed in the passages 237 (e.g. extending between walls 231a, 231b and/or from ribs 236) in order to provide a more consistent airflow and/or desirable airflow resistance to be communicated through the article 110 and to the user in use.

It is to be understood, however, that this disclosure is not to be limited to passages 237 being necessarily airflow passages. For example, the device 100 and/or heater assembly 200 could provide any suitable alternative or additional arrangement of airflow passages for supplying the necessary airflow for use of the device 100. For example, airflow passage(s) could be provided in the side of the device, or defined between the inner wall 231b and the article 110 itself. Airflow passage(s) could also be directed from the distal end of the device 100 and up through the base 233 instead or in addition.

The outer and inner wall 231a, 231b configuration of the receptacle 230 can facilitate improvements in the amount of insulation provided between the heating element 210 and the device housing 102 (e.g. compared to a single-walled receptacle 230). Also, if the passages 237 are used as airflow passages as discussed above, this may facilitate yet another improvement in the amount of insulation provided between the heating element 210 and the device housing 102 (e.g. as the (relatively cool external) airflow can absorb excess heat from the inner and outer walls 231a, 231b). The amount of insulation provided by the heater assembly 200 can be an important consideration for the device 100, as it may be necessary to prevent the device 100 becoming too hot in the user's hand or the temperatures becoming troublesome for other device components. By providing an air gap in the receptacle 230, it is possible to facilitate an improvement in the amount of insulation required in the device housing, leading to a compact device housing.

As discussed in passing above, the receptacle 230 is removable disposed within the chamber 105, such that it can be removed therefrom and replaced therein during use. In embodiments, the receptacle 230 is fixedly mounted in the device housing 102. The receptacle 230 may form part of the device housing 102. For example, the receptacle and the coil support may be integrally formed. The receptacle may be used in place of the coil support. In the depicted embodiments, the receptacle 230 is configured to interact with the chamber 105 in such a way that rotation of the receptacle 230 relative to the device housing 102 allows it to be engaged and disengaged in response to rotation of the receptacle 230.

The receptacle 230 and the device housing 102 include complementary interlocking features that are configured to engage or disengage in response to rotation of the receptacle 230 relative to the device housing 102.

Within the context of this disclosure, it should be understood that ‘engage’ relates to an engagement that holds the receptacle 230 in place sufficiently in the device housing 102 for use of the device 100, and ‘disengage’ relates to the releasing of such an engagement that allows the receptacle 230 to be removed from the device housing 102 (e.g. without having to remove other components of the device housing 102 or destroying parts of the device housing 102). A tool (not shown) can be used in combination with the receptacle 230 to aid insertion and removal of the receptacle 230 from the device chamber 105.

The receptacle 230 defines the heating chamber 220 extending between the opening 239 and the base 233. As such, the heating chamber 220 extends between the proximal end 233a and the distal end 233b. An inner side 253 of the wall 231 defines the heating chamber 220. In the present arrangement, the inner wall 231b substantially defines the inner side 253. The base 233 has an inner face 254 and an outer face 255. The inner side 253 of the wall 231 and the inner face 254 of the base 233 define the surface of the heating chamber 220. The base defines a floor of the heating chamber 220. The heating chamber 220 has a substantially uniform cross section along substantially the length of the receptacle 230 from the opening to the base 233.

The receptacle has a spacer configuration 260. The spacer configuration 260 spaces an end of the article 110 from the base 233 when the article 110 is received in the heating chamber 220. When the article 110 is received in the heating chamber 220, a portion of the article 110 protrudes from the heating chamber 220. In embodiments, the entire article 110 is received by the heating chamber 220.

The spacer configuration 260 comprises an array of protrusions 261. The present embodiment as shown in FIG. 4B has three protrusions 261, although only one is shown. It will be understood that the number of protrusions may differ, and may be one protrusion or a plurality of protrusions. The protrusion(s) 261 act as a spacer. The protrusions 261 upstand from the base 233. The protrusions 261 have a height in the heating chamber 220. Each protrusion 261 has a uniform height. The protrusions 261 act as a stop to limit the extent of insertion of the article 110 into the heating chamber 220. The protrusions 261 extend in the heating chamber 220. The protrusions 261 define an article locating face 262. The article locating face 262 abuts the end of the article 110.

The heating element 210 upstands from the base 233. The protrusions 261 are distributed in the heating chamber 220 around the heating element 210. In the present embodiment, the protrusions 261 are spaced from the heating element 210. In embodiments, the protrusion(s) 261 may extend from the heating element 210. The spacer configuration 260 may surround the heating element 210.

The protrusions 261 are platforms. The protrusions 261 define an air gap 265 between the base 233 and a plane of the article locating face 262. The air outlet 252 communicates with the air gap 265. When the article 110 is inserted into the heating chamber 220, the end of the article 110 abuts against the spacer configuration 260. The spacer configuration 260 therefore limits the extent by which the article 110 is inserted and therefore enables an air gap 265 to be formed between the base 233 and the end of the article 110. This air gap facilitates an improvement in the air flow to the end of the article 110. By providing the air gap, the spacer configuration 260 provides for an improvement in the distribution of airflow across the end of the article 110.

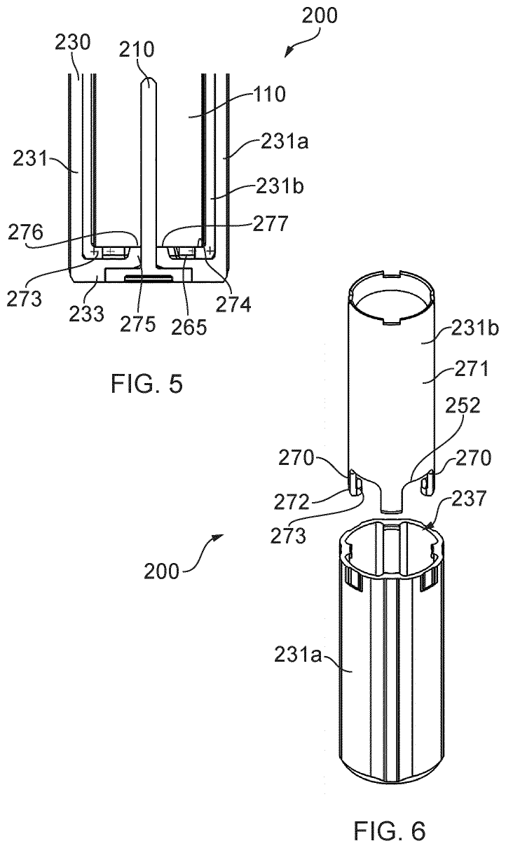

The spacer configuration 260 may take different forms. For example, the protrusions 261 may be one or more rods, ribs, tabs, lips, and hooks. The spacer configuration 260 may form a shoulder in the heating chamber 220. One such spacer configuration 260 is shown in FIGS. 5 and 6.

FIG. 5 shows a cross-sectional side view of part of another heater assembly 200. FIG. 6 shows an exploded view of the receptacle 230 of the another heater assembly 200. The heater assembly 200 in FIGS. 5 and 6 has generally the same arrangement as the heater assemblies described above and so a detailed description will be omitted. The heater assembly 200 includes the receptacle 230 and the heating element 210. The heating element 210 as shown in FIG. 5 is a pin heating element, however it will be understood that the arrangement of the heating element may differ. The receptacle 230 comprises the outer and inner walls 231a, 231b.

The cross-section in FIG. 5 is taken through the ribs 236 and so the air passage 237 is omitted, as well as the air outlet 252. In this embodiment, the inner wall 231b comprises legs 270 extending in an axial direction from the distal end. The legs 270 are circumferentially spaced about the inner wall 231b. Four legs 270 are shown, however the number of legs may differ. The legs 270 protrude from a body 271 of the inner wall 231b and space the inner wall body 271 from the base 233. Distal ends 272 of the legs 270 abut against the base 233. In embodiments the legs 270 are spaced from the base 233. An inwardly extending flange 273 protrudes from each leg 270. The inwardly extending flange 273 is a protrusion. The inwardly extending flange 273 protrudes from the distal end of each leg 270, however the flange 273 may be spaced from the distal end 272 of each leg 270. The flanges 273 act as locating tabs. The flanges 273 form the spacer configuration 260. The spacer configuration 260 may take different forms. For example, the protrusions 273 may be one or more rods, ribs, tabs, lips, and hooks. The flanges each have a height. The flanges 273 define the height of the air gap 265 formed between the end of the article 110 and the floor of the heating chamber 220. Each flange 273 defines the article locating face 274.

The air outlet 252 is defined between adjacent legs 270. The air outlet 252 is provided in a radial direction. In the present embodiment, the or each protrusion abuts the base 233 to axially locate the inner wall 231b, and the distance between the article locating face 274 and the base 233 is defined by the height of the flanges 273 acting as protrusions. In embodiments, the flanges are spaced from the base.

The flanges 273 form an outer spacer. The flanges 273 act as a shoulder. The receptacle 230 also comprise an inner spacer 275. The inner spacer 275 comprises an inner shoulder 276 upstanding from the floor of the heating chamber 220. The shoulder 276 comprises a raised collar extending around the heating element 210. The shoulder 276 defines an article locating face 277. The shoulder 276 is axially offset from the inner face 254 of the base 233. In each of the embodiments, the spacer configuration axially offsets the end of the article from the floor of the heating chamber 220.

The spacer arrangement facilitates spacing the article from the floor of the heating chamber 220. With the present arrangement, the provision of the air gap enables an improvement in airflow through the receptacle 230. By spacing the end of the article 110 from the base 233, the arrangement facilitates the flow of air into the heating chamber 220 in a radial direction. The air path is maintained solely within the receptacle 230. Accordingly, this facilitates condensate management in the device. Although the receptacle 230 is removable disposed within the chamber 105, such that it can be removed therefrom and replaced therein during use, in embodiments, the receptacle 230 is fixedly mounted in the device housing 102. In embodiments, the receptacle 230 forms part of the device housing 102. For example, the receptacle and the coil support may be integrally formed. The receptacle may be used in place of the coil support.

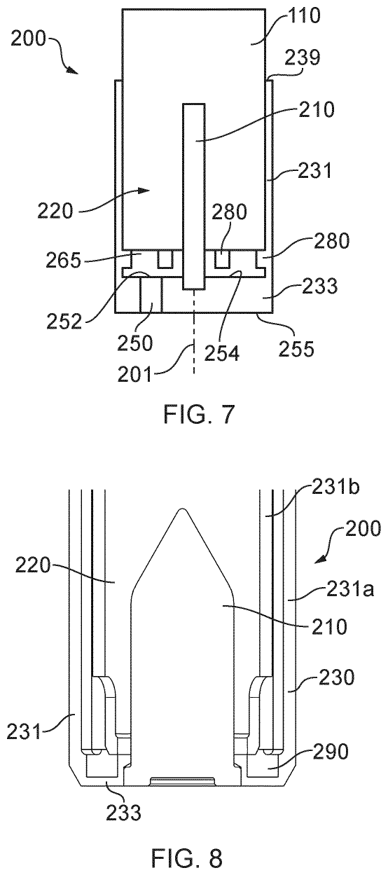

In the above described embodiments, the air outlet is described in an radial flow arrangement with the heating chamber. It will be understood that in embodiments, the air outlet may provide an axial flow arrangement with the heating chamber. Such an arrangement is shown in FIG. 7. The heater assembly 200 in FIG. 7 has generally the same arrangement as the heater assemblies described above and so a detailed description will be omitted.

With reference to the embodiment of FIG. 7, the receptacle 230 comprises the base 233 with part of the air path 250 extending in the base 233. In such an arrangement the receptacle 230 is a single wall arrangement, with the air path 250 extending through the base 233 between the outer face 255 and the inner face 254. In embodiments, the double wall arrangement is retained with the air path 250 extending from the wall 231 into the base 233.

Tabs 280, acting as protrusions, protrude from the side wall 231. The tabs 280 protrude radially inwardly. The number of tabs may differ, and may be one. The arcuate extent of the or each tab may differ. The tabs 280 are spaced from the base 233.

The air outlet 252 communicates with the floor of the base 233. One air outlet port is shown in the Figure, however in embodiments there are a number of air outlet ports forming the air outlet 252. The axis of the air outlet is defined by the center of overall flow from the base 233. The air outlet 252 is non-symmetrical about the axis 201 of the heating chamber 220. By providing the air gap 265 a substantially uniform air flow through the article 110 from the end of the article 110 is provided despite the non-symmetrical arrangement of the air outlet 252. It will be understood that the differing airflow paths described with each embodiment may be used with different spacer arrangements described herein.

Referring now to FIG. 8, a further embodiment will now be described. The embodiment of FIG. 8 has generally the same arrangement as the heater assemblies described above, and in particular the embodiment of FIGS. 5 and 6, and so a detailed description will be omitted.

The heater assembly 200 includes the receptacle 230 and the heating element 210. The heating element 210 as shown in FIG. 8 is a blade heating element, however it will be understood that the arrangement of the heating element may differ. The receptacle 230 comprises the outer and inner walls 231a, 231b. The heating element 210 upstands in the heating chamber 230. The heating element 220 extends from the base 233. The base 233 and the outer wall 231a form a cup.

The base 233 includes a well 290. The well 290 is configured to collate liquid in the heating chamber 230. The well 290 comprises a cavity 291. The cavity 291 extends in the base 233. The number of cavities 291 may differ. The or each cavity 291 extends arcuately about the axis of the heating chamber 220. The cavity 291 is a blind recess. The cavity extends from the floor of the heating chamber 220. The well 290 may be formed in the wall 231 of the receptacle 230. The cavity 291 defines a recess away from the air flow into and through the heating chamber 220. As such, it is possible for condensate, for example, to collate in the cavity 291 and so be away from the air flow. As such, a free air path without condensate is promoted.

By collating condensate in the heating chamber in the cavity 291 it is possible to facilitate the drawing away of the condensate from the air path and provide space for the condensate to evaporate and be expelled from the heating chamber 220.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. An aerosol provision device comprising:
a heater assembly having:
a heating chamber arranged to receive at least a portion of an article comprising aerosol generating material, and
a heating element configured to heat a portion of the article received in the heating chamber;
a base at one end of the heating chamber; and
a spacer configured to space the article from the base when at least the portion of the article is received in the heating chamber.

2. The aerosol provision device of claim 1, wherein the spacer comprises a protrusion protruding into the heating chamber.

3. The aerosol provision device of claim 2, wherein the protrusion is one of a plurality of protrusions.

4. The aerosol provision device of claim 3, wherein the plurality of protrusions are distributed around the heating chamber.

5. The aerosol provision device of claim 2, wherein the protrusion extends from the base.

6. The aerosol provision device of claim 2, wherein the protrusion is spaced from the base.

7. The aerosol provision device of claim 1, wherein the spacer forms a shoulder in the heating chamber.

8. The aerosol provision device of claim 1, wherein the heating element upstands from the base.

9. (canceled)

10. The aerosol provision device of claim 1, further comprising a receptacle defining the heating chamber, wherein the base forms part of the receptacle.

11. The aerosol provision device of claim 10, further comprising a device housing, wherein the receptacle is removable from the device housing.

12. (canceled)

13. The aerosol provision device of claim 10, wherein the receptacle defines an air passage to provide airflow to the heating chamber.

14. The aerosol provision device of claim 13, wherein the air passage comprises an air outlet into the heating chamber, and wherein the air outlet is defined in the base.

15. The aerosol provision device of claim 14, wherein the air outlet is non-symmetrical about an axis of the heating chamber.

16. The aerosol provision device of claim 13, wherein the air passage comprises an air outlet into the heating chamber, the air outlet being at least partially disposed between the base and an article locating face of the spacer.

17. The aerosol provision device of claim 16, wherein the air outlet is arranged to introduce air flow into the heating chamber in a radial direction relative to a longitudinal axis of the receptacle.

18-20. (canceled)

21. The aerosol provision device of claim 1, wherein the heater assembly comprises an inductor coil extending around a susceptor that is heatable by penetration with a varying magnetic field, wherein the inductor coil is configured to generate the varying magnetic field.

22. The aerosol provision device of claim 1, further comprising an opening at a proximal end of the heating chamber, and wherein the base is at a distal end of the heating chamber, and wherein the heating chamber has a substantially uniform cross section along substantially a length of a receptacle defining the heating chamber.

23. The aerosol provision device of claim 1, wherein the base includes a well configured to collect liquid collated in the heating chamber.

24. A heating assembly, comprising:
a receptacle for receiving at least a portion of an article comprising aerosolizable material the receptacle comprising:
a base, and
a heating element extending from the base; and
a protrusion for contacting the portion of the article when the portion of the article is received in the heating chamber such that the article is maintained a distance above the base.

25. (canceled)

26. An aerosol provision device comprising:
a heater assembly having:
a heating chamber arranged to receive at least a portion of an article comprising aerosol generating material, and
a heating element configured to heat a portion of the article received in the heating chamber;
a wall defining at least part of the heating chamber; and
a cavity formed in the wall.

27. The aerosol provision device of claim 26, comprising at least one of a base at one end of the heating chamber, wherein the wall comprises the base and the cavity is in the base, and a peripheral wall defining the heating chamber, wherein the wall comprises the peripheral wall and the cavity is in the peripheral wall.

28. (canceled)

29. (canceled)

30. The aerosol provision device of claim 26, further comprising a device housing and a receptacle arranged to be at least partially removably received in the device housing, wherein the receptacle forms the heating chamber.

31-33. (canceled)

34. A heating assembly, comprising:
a heating chamber for receiving at least a portion of an article comprising aerosolizable material; and
a heating element;
wherein the heating chamber has a base and a recess in the base for collecting fluid received in the heating chamber.

35. An aerosol provision system comprising:
the aerosol provision device of claim 1; and
the article comprising the aerosol generating material, wherein the article is dimensioned to be at least partially received within the heater assembly.
